(19) United States
(12) Patent Application Publication
(10) Pub. No.: US 2024/0301175 A1
(43) Pub. Date: Sep. 12, 2024

(54) BITUMEN-AGGREGATE INTERFACE MODIFIERS

(71) Applicants: Elham Fini, Phoenix, AZ (US); Saba Shariati, Shenzhen (CN)

(72) Inventors: Elham Fini, Phoenix, AZ (US); Saba Shariati, Shenzhen (CN)

(21) Appl. No.: 18/600,181

(22) Filed: Mar. 8, 2024

Related U.S. Application Data
(60) Provisional application No. 63/489,410, filed on Mar. 9, 2023.

(51) Int. Cl. C08K 9/06; C08L 95/00; C09C 1/30; C09C 3/08; C09C 3/12

(52) U.S. Cl. CPC C08K 9/06; C08L 95/00; C09C 1/3063; C09C 1/3081; C09C 3/08; C09C 3/12; C01P 2004/50

(57) ABSTRACT

A modified bitumen composite includes bitumen, a multiplicity of particles comprising silicate, and a modifier comprising one or more organosilanes, one or more bio-oils, or both, wherein the modifier at least partially coats each particle of the multiplicity of particles. Making the modified bitumen composite includes combining bitumen, the multiplicity of particles comprising silicate, and the modifier to form a mixture, and heating the mixture to yield the modified bitumen composite.

### CROSS-REFERENCE TO RELATED APPLICATION

This application claims the benefit of U.S. Patent Application No. 63/489,410 filed on Mar. 9, 2023, which is incorporated by reference herein in its entirety.

### STATEMENT OF GOVERNMENT SUPPORT

This invention was made with government support under grant number 1935723 awarded by the National Science Foundation. The government has certain rights in the invention.

### TECHNICAL FIELD

This invention relates to a method of making a modified bitumen-aggregate composition with improved bitumen-aggregate adhesion, as well as the resulting modified bitumen-aggregate composition.

### BACKGROUND

Asphalt concrete is a mixture of a viscous petroleum binder called bitumen and hard, inert materials called aggregates. The composition of bitumen is a complex mixture of low polarity hydrocarbon molecules and relatively higher polarity asphaltene molecules that have dense aromatic cores and polar nitrogen and oxygen atoms. Asphalt aggregates include siliceous material such as sand, gravel, crushed stone, slag, or rock dust. The surfaces of the aggregate material often include polar functional groups. The quality and service life of an asphalt concrete depend largely on the strength and stability of the bitumen-aggregate adhesion; inadequate adhesion results in typical instabilities such as crumbling, stripping, raveling, and pothole development.

### SUMMARY

This disclosure describes bio-oil and organosilane modifiers of bitumen-aggregate mixtures. The modifiers interact with both the bitumen and the mineral aggregates within the bituminous mixture and can act as adhesion promoters between the bitumen and the aggregates. The modifiers have an affinity toward aggregates and can change the surface chemistry of aggregates, which in turn changes the type and strength of the interactions of the aggregates with bitumen.

The bio-oil modifier with multiple functional groups described herein can interact with both bitumen and siliceous aggregates to improve the adhesive properties of bituminous composites. The bio-oils derived from waste bio-masses are environmentally friendly, with multi-functional active groups and multi-functional performance, that can improve the sustainability and durability of bituminous composites by increasing the stone-bitumen adhesion.

The organosilane modifier added to bitumen can improve pavement performance by enhancing the resistance to moisture at the bitumen-aggregate interface. The optimum dosage of organosilanes can improve the bitumen-aggregate adhesion in wet conditions. The performance of the optimum organosilane-modified bitumen was not reduced after being exposed to short-term aging and long-term aging, indicating low susceptibility to thermal and oxidative degradation.

A modified bitumen composition includes bitumen, a multiplicity of particles including silicate, and a modifier including one or more organosilanes, one or more bio-oils, or a combination of one or more organosilanes and one or more bio-oils. The modifier at least partially coats each particle of the multiplicity of particles. Coating each particle includes the modifier chemisorbed, physisorbed, or both to a surface of the particle. The multiplicity of particles can include aggregates such as sand, gravel, crushed stone, slag, or rock dust.

The bio-oils can include waste bio-oils. The bio-oil used can be an aromatic/aliphatic mixture containing nitrogen and oxygen heteroatoms. The molecules of this bio-oil have a high tendency to adsorb to a silica surface. The bio-oils can include one or more of N-methyl-2-pyrrolidone, 1-butyl-piperidine, p-presol, and 1-methyl-9H-pyrido[3,4-b] indole.

The organosilanes can include one or more silicon atoms, a polar hydrolysable head group, and a hydrophobic organic tail group. Suitable organosilanes include butyl(triethoxy)silane, triethoxyoctylsilane, triethoxy(tert-pentyl)silane, triethoxy(heptyl)silane, and triethyl(pentyloxy)silane.

Making a modified bitumen composite includes combining bitumen, a multiplicity of particles including silicate, and a modifier to form a mixture, and heating the mixture to yield the modified bitumen composite. The modifier includes one or more organosilanes, one or more bio-oils, or a combination of one or more organosilanes and one or more bio-oils. A weight ratio of the bio-oils to bitumen can be in a range of about 1:50 to about 1:4. A weight ratio of the organosilanes to bitumen can be in a range of about 0.1:100 to about 1:100, or about 0.55 to about 0.65:100. Heating the mixture can include heating the mixture to a temperature in a range of about 100° C. to about 180° C. for a length of time in a range of about 5 minutes to about 120 minutes.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 depicts the formation of the bio-coated silica from silica and a bio-oil derived from a mixture of biomasses. Bio-oil molecules bridge between the bitumen and the silica.

FIG. 2 depicts the formation of organosilane-coated silica from butyl(triethoxy)silane and silica. Organosilane bridges between the bitumen and the silica.

FIGS. 3A and 3B show plots of the viscosity versus shear rate and the shear thinning values, respectively, for bitumen modified with bio-oil, control bitumen, and bitumen modified with organosilane.

FIG. 4 shows a plot of the percentage increase in adsorption energy to bitumen by shifting from the organosilane-coated silica to the bio-coated silica. % ΔE was obtained by comparing the mean adsorption energy values for bitumen-(bio-coated silica) and bitumen-(organosilane-coated silica).

FIG. 5 is a schematic diagram of parallel-plate device.

FIG. 6 is a plot of viscosity versus shear rate showing regions of zero shear viscosity, shear thinning, and the onset of shear thinning.

FIGS. 7A-7C show plots of the moisture-induced shear-thinning index (MISTI) deviation from 1 for bitumens containing different dosages of the organosilane modifier (OS1) before curing, after curing at a temperature of 130° C., and after curing at a temperature of 150° C., respectively.

FIG. 8 shows a plot of MISTI deviation from 1 for bitumens containing different dosages of OS1 (cured at 150° C. for 60 min), and bitumen containing OS1-treated glass beads (TGB) (dashed red line).

FIGS. 9A and 9B show plots of viscosity versus shear rate and MISTI deviation from 1, respectively, for bitumen containing 0.6% OS1 (cured at 150° C. for 60 min) before aging, after short-term aging in a rolling thin-film oven (RTFO), and after long-term aging in a pressure aging vessel (PAV).

FIGS. 10A and 10B show plots of water contact angles on silane coatings with respect to casting and curing method, and hydrolysis, respectively. Error bars are 95% confidence intervals.

FIG. 11 shows a plot of contact-angle measurements of OS1 films spin-coated from extra-diluted solutions.

### DETAILED DESCRIPTION

This disclosure describes a bitumen modifier including organosilanes and bio-oils that interact with molecules of bitumen and the surface of aggregates to improve the bitumen-aggregate adhesion. The modifier can act as a bridge between organic and inorganic components of the bitumen-aggregate mixture, thereby increasing and strengthening the intermolecular reactions between the bitumen and aggregate.

A modified bitumen composition includes bitumen, a multiplicity of particles including silicate, and a modifier including one or more organosilanes, one or more bio-oils, or a combination of one or more organosilanes and one or more bio-oils. The modifier at least partially coats each particle of the multiplicity of particles. Coating each particle includes the modifier chemisorbed, physisorbed, or both to a surface of the particle. The multiplicity of particles can include aggregates such as sand, gravel, crushed stone, slag, or rock dust.

The bio-oils can include waste bio-oils. The bio-oil used can be an aromatic/aliphatic mixture containing nitrogen and oxygen heteroatoms. The molecules of this bio-oil have a high tendency to adsorb to a silica surface. The bio-oils can include one or more of N-methyl-2-pyrrolidone, 1-butyl-piperidine, p-presol, and 1-methyl-9H-pyrido[3,4-b] indole.

The organosilanes can include one or more silicon atoms, a polar hydrolysable head group, and a hydrophobic organic tail group. Suitable organosilanes include butyl(triethoxy)silane, triethoxyoctylsilane, triethoxy(tert-pentyl)silane, triethoxy(heptyl)silane, and triethyl(pentyloxy)silane.

Making a modified bitumen composite includes combining bitumen, a multiplicity of particles including silicate, and a modifier to form a mixture, and heating the mixture to yield the modified bitumen composite. The modifier includes one or more organosilanes, one or more bio-oils, or a combination of one or more organosilanes and one or more bio-oils. A weight ratio of the bio-oils to bitumen can be in a range of about 1:50 to about 1:4. A weight ratio of the organosilanes to bitumen can be in a range of about 0.1:100 to about 1:100, or about 0.55 to about 0.65:100. Heating the mixture can include heating the mixture to a temperature in a range of about 100° C. to about 180° C. for a length of time in a range of about 5 minutes to about 120 minutes.

### EXAMPLES

### Example 1

Materials. Bitumen with grade PG 64-22 was acquired from HollyFrontier Corporation with properties provided in Table 1. The specimens were prepared by blending bitumen with glass beads with a diameter of 100 microns in a ratio of 2:1 at a temperature of 150° C. for 5 minutes. The organosilane modifier was acquired from Zydex Industries.

TABLE 1
Physical properties of bitumen PG64-22

| Property | Value | | AASHTO Standard |
|---|---|---|---|
| Specific Gravity at (15.6° C.) | 1.041 | | T 228 |
| Flash point | 335° | C. | T 48 |
| Change in Mass (RTFO) | −0.013 | | T 240 |
| Absolute Viscosity at 60° C. | 179 | Pa · s | T 202 |
| Stiffness @−12° C. @ 60 s | 71.67 | MPa | T 313 |

Sample preparation. Modification of bitumen was carried out by the addition of modifiers separately to bitumen; mixing was performed at a temperature of 130° C. to 170° C. (e.g., 150° C.) for 3-10 minutes (e.g., 5 minutes) using a stainless-steel lab spoon. To prepare the bitumen modified with bio-oil, 5-15% (e.g., 10%) bio-oil was added into bitumen by weight of bitumen. To prepare the bitumen modified with organosilane, 0.4-1% (e.g., 0.6%) organosilane (by bitumen's weight) was incorporated into the bitumen. Following that, the glass beads were introduced to the modified bitumens at a ratio of about 2:1 to 3:1 (bitumen to glass beads). The mixture of bitumen modified with bio-oil and glass beads was ready for testing; the mixture of bitumen modified with organosilane and glass beads was cured at a temperature of 130° C. to 170° C. (e.g., 150° C.) for 45-90 min (e.g., 60 min) before testing.

Shear test at the interface. The shear-thinning behavior of a bituminous composite can be sensitive to changes at the interface of bitumen and stone, and the shear-thinning test is able to provide consistent, repeatable results. This test can be used to specifically decouple the properties of bitumen's interface from the properties of bitumen's bulk. A shear-rate ramp test was performed on a mixture of glass beads and bitumen (bitumen modified with bio-oils or bitumen modified with organosilane), using an Anton Paar MCR 302 dynamic shear rheometer with an 8-mm spindle. Mixtures containing a 2:1 ratio of bitumen and glass beads were placed in silicon molds to form 8-mm disk-shaped specimens. Each specimen was then demolded and placed in a parallel-plate test setup of a dynamic shear rheometer. A ramping shear rate (0.1 to 100 1/s) was applied to the specimen, and the viscosity value was measured at each shear rate. The testing temperature was adjusted so that the initial viscosity was about 1000 Pa s for all studied scenarios regardless of modifier type. A plot of viscosity versus shear rate was then used for analysis. Three types of bitumen were tested: control bitumen, bitumen modified with organosilane, and bitumen modified with bio-oil.

Computational method. Density functional theory (DFT) was used to characterize the adhesion strength between the candidate molecules of bitumen and the two types of coated silica models, bio-coated silica and organosilane-coated silica. Non-periodic DFT calculations were done using the Dmol3 modulus implemented in the Accelrys Materials Studio program package (version 7). The Perdew-Burke-Ernzerhof (PBE) exchange-correlation functional with Grimme's dispersion correction (PBE-D) and all-electron double-numerical polarized basis set (DNP) were applied. The convergence criteria for the geometric optimizations were 2.0×10⁻⁵ hartree, 4.0×10⁻³ hartree/A, and 5.0×10⁻³ Å for energy, maximum force, and displacement, respectively. Adsorption energies were calculated using Eq. 1:

$${E}_{ads} = {E}_{complex} - ( \sum {E}_{fragment} ) \qquad ( 1 )$$

in which E_{complex} is the total energy of the interacting complex including a bitumen component adsorbed on a coated silica surface, and E_{fragment} is the energy of a fragment within the complex.

Only the uppermost sheet of the silica cluster (including the atoms that have a chance to take part in interactions) was optimized; the remaining bottom atoms of the cluster were kept fixed to preserve the bulk-like rigidity.

Molecular modeling. A Preliminary Periodic Boundary Condition (PBC) approach was used to model the silica surface. A 3×3×1 Å super cell was built from the unit cell of α-quartz with optimized parameters of a=b=4.928 Å, c=5.428 Å, α=β=90.0°, and γ=120.0°. The silica super cell was then fully optimized at the PBE-D level and with quality of “fine” grid using CASTEP modulus embedded in the Accelrys Materials Studio program package (version 7). A (001) Miller basal plane was cleaved out of the optimized 3×3×1 super cell to obtain the silica surface model. Dangling bonds were saturated with H and OH end groups, and the periodic condition was removed to obtain the silica cluster model that was used for this study.

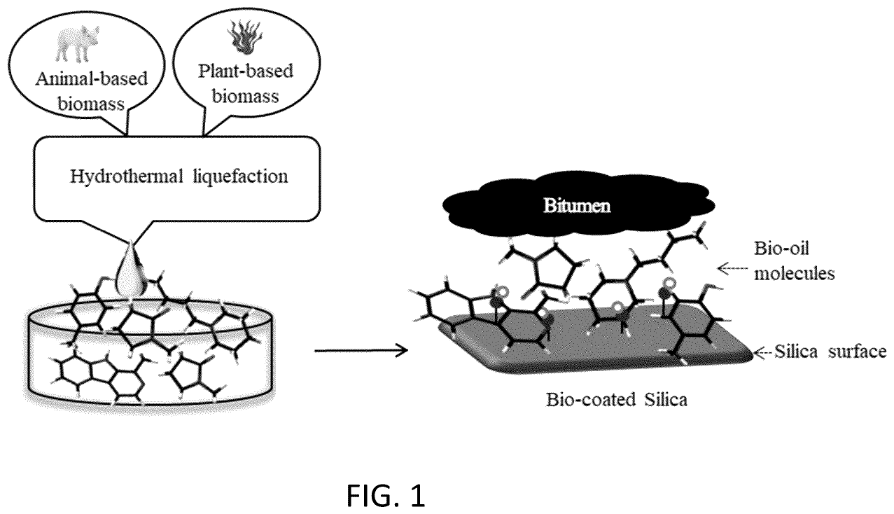

Bio-coated silica. The hybrid bio-oil used here is composed of an aromatic/aliphatic mixture containing nitrogen and oxygen heteroatoms. The molecules of this hybrid bio-oil have a high tendency to adsorb to a silica surface. Among those molecules, N-methyl-2-pyrrolidone and 1-butyl-piperidine were able to make strong adhesions to silica and even displaced the deposits of aged bitumen on silica. Polar fused aromatic and alkyl-substituted phenolic compounds can also be adsorbed strongly to the silica surface through the formation of hydrogen bonds with the silanol groups of silica and through the π-polar attractions between their aromatic rings and the polar silica surface. Considering these points, a silica cluster model with candidate bio-oil molecules (N-methyl-2-pyrrolidone, 1-butyl-piperidine, p-presol, and 1-methyl-9H-pyrido[3,4-b]indole) adsorbed on its surface was used as bio-coated silica. The formation of bio-coated silica and the bridging role of bio-oils are shown in FIG. 1.

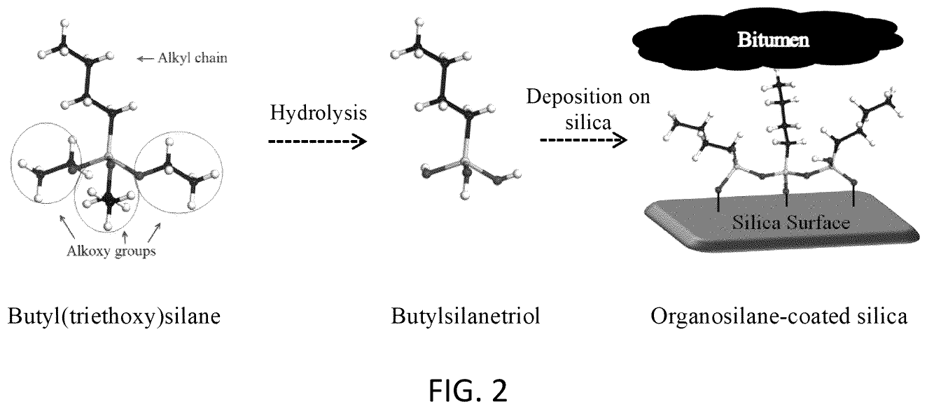

Organosilane-coated silica. An organosilane with a polar hydrolysable head and a hydrophobic organic tail can bridge between a hydrophilic compound (such as an inorganic mineral surface) and a hydrophobic medium (such as a bitumen hydrocarbon), leading to an improvement in their interfacial adhesion. The model organosilane used in this study was butyl(triethoxy)silane. According to the mechanism of action of these silane coupling agents, the alkoxy groups on a silicon atom are hydrolyzed to hydroxyl groups, then the silanols can coordinate with the hydroxyl groups of a mineral surface. The molecules of an organosilane can also coordinate with each other, leading to the formation of a polymer film on an inorganic surface. This mechanism is schematically illustrated in FIG. 2. The organosilane-coated silica used for this study is composed of two trimers of butyl(triethoxy)silane covalently bonded to the silica surface, forming new siloxane rings.

Bitumen molecules. The molecular geometries of the candidate bitumen components are shown in Table 2. To model the bitumen components, five molecules were selected with different structures and heteroatoms: asphaltene pyrrole, quinoline resin, benzobisbenzothiophene, naphthalene, and benzoic acid.

TABLE 2
Adsorption energies (E_{ads} in kcal/mol) for adsorption of bitumen
molecules on bio-coated silica and on organosilane-coated silica.

| | | Adsorption on |
|---|---|---|
| | Adsorption on | organosilane-coated |
| | bio-coated silica | silica |
| Asphaltene pyrrole | E_{ads} = −84.2 to −96.8 | E_{ads} = −66.4 to −74.4 |
| Quinoline resin | E_{ads} = −58.9 to −73.8 | E_{ads} = −45.5 to −58.8 |
| Benzobisbenzothiophene | E_{ads} = −21.3 to −24.6 | E_{ads} = −20.2 to −21.4 |
| Benzoic acid | E_{ads} = −21.8 to −26.6 | E_{ads} = −11.4 to −16.7 |
| Naphthalene | E_{ads} = −21.8 to −28.9 | E_{ads} = −18.8 to −25.8 |

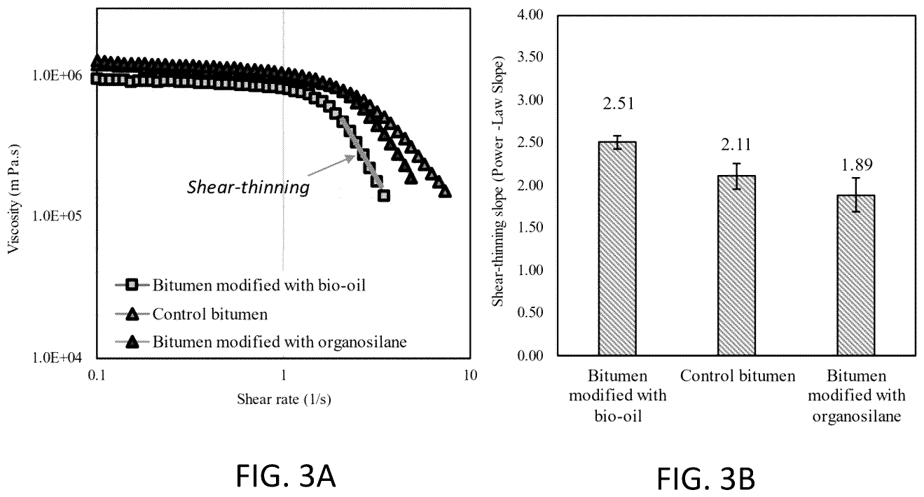

Results of shear test at the interface. The shear-thinning value is sensitive to changes at the interface of bitumen and stone aggregates; the shear-thinning value is highly sensitive to changes in interfacial bonds. The capability of the shear-thinning test to detect any changes at the interface has been shown by changing the surface chemistry of siliceous particles, altering the interfacial bond. The surface property of silica (as a surrogate for siliceous aggregates) is altered by either bio-oil or organosilane coating materials. The test is used to compare the adhesion strength at the interface of bitumen-silica with and without the coating modifiers. FIGS. 3A and 3B show plots of the viscosity measured at different shear rates and the shear thinning, respectively, for the control bitumen, bitumen modified with organosilane, and bitumen modified with bio-oil. The interaction between the bitumen and the glass beads is closely related to the shear-thinning value; a steeper shear-thinning value indicates greater interaction between the bitumen and the glass beads. According to these results, the bitumen modified with bio-oil had the highest shear-thinning value (2.51), followed by the control bitumen (2.11) and the bitumen modified with organosilane (1.89). The results indicate the effectiveness of the bio-oil in promoting the intermolecular interactions between the bitumen and aggregates. The lower shear-thinning value for the bitumen modified with organosilane than for the control bitumen highlights the ineffectiveness of the organosilane modifier at strengthening the bitumen-aggregate adhesion. In fact, the use of the organosilane modifier disrupted the intermolecular interactions in dry conditions. Dry-surface adhesion to bitumen of an organosilane-coated glass bead can be notably less than that of UV-ozone-cleaned glass. To further analyze the interfacial adhesion strength and interfacial bonds, molecular modeling calculations were performed.

DFT-based calculations of the interaction of bitumen components with bio-coated silica or with organosilane-coated silica. Molecular modeling calculations were used to compare the adhesion strength at the bitumen-aggregate interface by using bio-oil or organosilane coating materials. The interactions of the candidate bitumen molecules with bio-coated silica or organosilane-coated silica were calculated. For each bitumen molecule, different orientations on the coated silica surfaces were considered; hence, a range of adsorption energies (E_{ads}) was reported for each adsorption and provided in Table 2. In the following, the detailed information on each adsorption interaction is explained, and the components of bio-oil with major contributions to the adhesion strength are introduced.

Asphaltene pyrrole. The results showed that asphaltene was adsorbed almost parallel to the bio-coated silica, providing both π-π attraction and hydrogen bonding with molecules of bio-oil. In the most stable adsorption complex (E_{ads}=−96.8 kcal/mol), the condensed aromatic rings of asphaltene were orientated mainly on top of the 1-methyl-9H-pyrido[3,4-b] indole and 1-butyl-piperidine bio-oil molecules, and the polar NH group (of pyrrole ring) formed a hydrogen bond with the oxygen atom of the N-methyl-2-pyrrolidone molecule (NH^{δ+} . . . ^{-δ}C). For the case of organosilane-coated silica, the most stable adsorption complex (E_{ads}=−74.4 kcal/mol) was the one in which the asphaltene molecule could interact with both vertical and bent alkyl branches of the organosilane on silica. The least adsorption energy occurred with the parallel orientation of asphaltene on top of the vertical alkyl chains (−66.4 kcal/mol).

Quinoline resin. This resin has basic nitrogen in its structure. The hydrogen atom of the N—H bond in the 1-methyl-9H-Pyrido[3,4-b] indole molecule and the phenolic hydrogen of the p-cresol molecule are active targets for polar-polar interactions between the quinoline resin and bio-coated silica. According to the results, the adsorption complex with electrostatic attraction (NH^{δ+} . . . ^{-δ}N) between quinoline resin and 1-methyl-9H-pyrido[3,4-b] indole had the highest adsorption energy (−73.8 kcal/mol). The interaction of quinoline resin with alkyl branches of organosilane was accompanied by a stabilization energy of −58.8 kcal/mol.

Benzobisbenzothiophene. The benzobisbenzothiophene molecule has been reported as a polar aromatic resin in bitumen. Furthermore, it contains sulfur atoms and can be used as a molecular model for sulfur-containing aromatic compounds in bitumen. The results showed a parallel adsorption of this molecule to the bio-coated silica cluster, and the highest adsorption energy (E_{ads}=−24.6 kcal/mol) was related to a complex having π-π and electrostatic attractions between the resin molecule and both the 1-methyl-9H-pyrido[3,4-b] indole and the p-cresol molecules of the bio-oil. The orientation of the resin molecule adsorbed to the organosilane-coated silica was very similar to that of asphaltene; the most stable complex had an adsorption energy of −21.4 kcal/mol.

Benzoic acid. Benzoic acid is a polar single-ring aromatic with a carboxylic acid functional group. The acidic hydrogen of benzoic acid has an important role in the interaction between benzoic acid and bio-coated silica. In the most stable adsorption complex, a hydrogen bond between benzoic acid and N-methyl-2-pyrrolidone (COOH^{δ+} . . . ^{-δ}OC) was formed, and the aromatic ring of benzoic acid stayed parallel to the bio-coated silica surface. The adsorption energy for this complex was −26.6 kcal/mol. The maximum adsorption energy for adsorption of benzoic acid to the organosilane-coated silica was only −16.7 kcal/mol.

Naphthalene. Naphthalene was selected as a small fused-ring non-polar aromatic molecule in bitumen. The maximum adsorption energy (E_{ads}=−28.9 kcal/mol) was obtained for the adsorption of naphthalene on top of the 1-butyl-piperidine molecule of the bio-coated silica. In this adsorption complex, the presence of naphthalene promoted a proton transfer from a silanol group of silica to the nitrogen atom of the 1-butyl-piperidine molecule of the bio-oil. The π-electron cloud of naphthalene stabilized the positively charged nitrogen (C₃N⁺H) of the 1-butyl-piperidine molecule. For the case of organosilane-coated silica, naphthalene, with smaller size compared to other candidate bitumen molecules, could penetrate in between the bent and vertical alkyl branches of the organosilane, providing −25.8 kcal/mol stabilization energy. This energy is higher than the energy for the adsorption of a resin molecule on organosilane-coated silica (−21.4 kcal/mol).

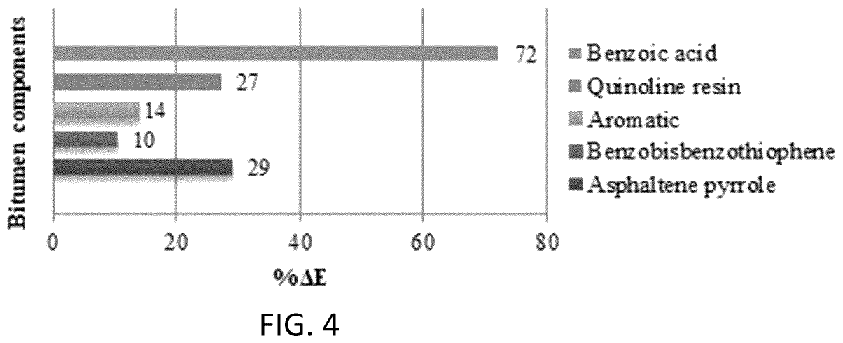

The percentage increase in adsorption energy, when shifting from using the organosilane-coated silica to the bio-coated silica, was calculated for the adsorption of each candidate bitumen molecule. The results are shown in FIG. 4. For each adsorption complex, the mean adsorption energy value (E_{ads(mean)}) was calculated using the formula E_{ads(mean)}=[E_{ads(max)}+E_{ads(min)}]/2; E_{ads(max)} and E_{ads(min)} are respectively the maximum and minimum adsorption energies reported in Table 2 for each adsorption complex. The % ΔE (reported in FIG. 4) was calculated by comparing the E_{ads(mean)} for the bitumen-(bio-coated silica) and the E_{ads(mean)} for the bitumen-(organosilane-coated silica). The overall results showed higher adsorption energies for the bio-coated silica complexes than for the organosilane-coated silica complexes. The stronger adhesion of bitumen molecules to the bio-coated silica was more pronounced for the oxygen/nitrogen-containing aromatics such as benzoic acid (72%), asphaltene pyrrole (29%), and quinoline resin (27%).

Effects of the polar and the aromatic functional groups on adhesion in bio-coated complexes. As shown by the results, the interactions of the polar and aromatic bitumen molecules with the bio-oil molecules influence the adhesive property of bitumen-(bio-coated silica) complexes. The bio-oil described in this disclosure is a material with multi-functional groups containing oxygen and nitrogen heteroatoms. Both acidic and basic molecules are present in the bio-oil compound as well as in the bitumen compound; consequently, different types of hydrogen bonds can form between the bitumen molecules and the bio-oil molecules. For instance, electronegative oxygen and nitrogen atoms in bio-oil molecules such as N-methyl-2-pyrrolidone and 1-butyl-piperidine could form strong hydrogen bonds with acid compounds in bitumen. On the other hand, hydrogens of amine groups in bio-oil molecules such as 1-methyl-9H-pyrido[3,4-b] indole could be targets for hydrogen bonding by basic molecules of bitumen such as quinoline resin. In this way, suitable conditions are provided for different electrostatic attractions between bio-coated silica and the polar and aromatic molecules of bitumen. In addition, π-π interactions between bitumen and bio-oil molecules further stabilize the adhesion between bitumen and bio-coated silica. Electrostatic interactions between the bio-coated silica and asphaltene pyrrole, quinoline resin, and benzoic acid, respectively, facilitate formation of adsorption complexes in which hydrogen bond formation and 71-71 attractions between the bitumen and bio-oil molecules led to high stabilization. The absence of these types of interactions in complexes with organosilane makes the adsorption strength lower in those complexes.

The bio-oil disclosed here also has the ability to rejuvenate aged bitumen and peptize the agglomerated bitumen compounds. The bio-oil can be dispersed well in a bitumen composite and can increase the intermolecular interactions within a bitumen mixture. An environmentally friendly modifier such as a bio-oil derived from waste bio-masses, with multi-functional active groups and multi-functional performance, can improve the sustainability and durability of bituminous composites by increasing the stone-bitumen adhesion.

### Example 2

Materials. To investigate the effect of organosilane modifier (OS1) on reducing moisture susceptibility, a bitumen known to be highly susceptible to moisture was used. Glass beads for use in the MISTI test were acquired through Gesswein. The organosilane modifier (OS1) is an alkoxy-alkylsilyl compound acquired from Zydex Industries. (3-Aminopropyl) triethoxysilane (APTES, ≥98%) and (1,1,1,3,3,3-hexamethyldisilazane) (HMDS, ≥99%) were obtained from BeanTown Chemical. Acetone, ethanol, and toluene were obtained through VWR International.

Sample preparation. To prepare OS1-modified bitumen, various dosages of OS1 (0.1%, 0.5%, 0.6%, 0.7%, 0.8%, 0.9%, and 1% by weight of bitumen) were added to bitumen. Glass beads were then introduced to the OS1-modified bitumen at a 2:1 to 3:1 ratio of bitumen to glass beads. The mixtures then were cured at two temperatures (130° C., 150° C.) for three durations (20, 40, and 60 minutes).

For tests of contact angle and hydrothermal stability, microscope glass slides (VWR International, LLC) were cut into 1″×0.5″ pieces and rinsed by ultrasonication first in acetone for 5 min and then in deionized (DI) water for 5 min. The glass was lightly dried under a stream of compressed air, and the surface was then cleaned by 5 min UV-ozone treatment in an SC-UV-I UV-ozone cleaner (Setcas, LLC). The glass slides were either spin-coated (1000 RPM, 1 min) or dip-coated with 1:20 diluted aqueous OS1 solution and allowed to dry under ambient conditions. Samples were measured immediately as cast or after curing at 110° C. on a hotplate for 15 min. Most samples were measured again after 3 days of storage under ambient conditions (20° C.), before hydrolysis. For comparison, glass slides were also solution-coated with APTES (2% by volume in ethanol with 5% water) or HMDS (2% by volume in toluene). In both cases, the glass slides were immersed in silane solutions for at least 30 min, then rinsed with ethanol and deionized (DI) water, dried with compressed air, and cured on a hotplate at 110° C. for 15 min.

To prepare the treated glass beads (TGB), the glass beads were treated with OS1. To do so, the glass beads were dipped into a solution of OS1 and water (1:20) for about 3-10 minutes (e.g., 5 minutes), followed by drying at ambient temperature for two days. These treated glass beads were then dried for about 1-3 hours (e.g., 2 hours) at a temperature of about 80° C. to about 120° C. (e.g., 100° C.), followed by pressing them softly to eliminate the agglomeration, ensuring a free-flowing powder. The TGB then were stored in a clean bag and closed tightly to avoid contamination. Comparison of microscopic images of TGB and non-treated glass beads show that the TGB have spots, indicating the efficacy of the treatment grafting OS1 onto the glass beads.

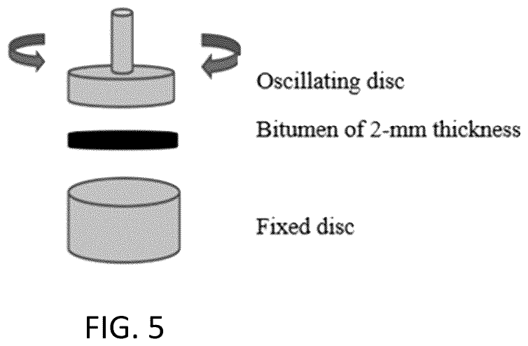

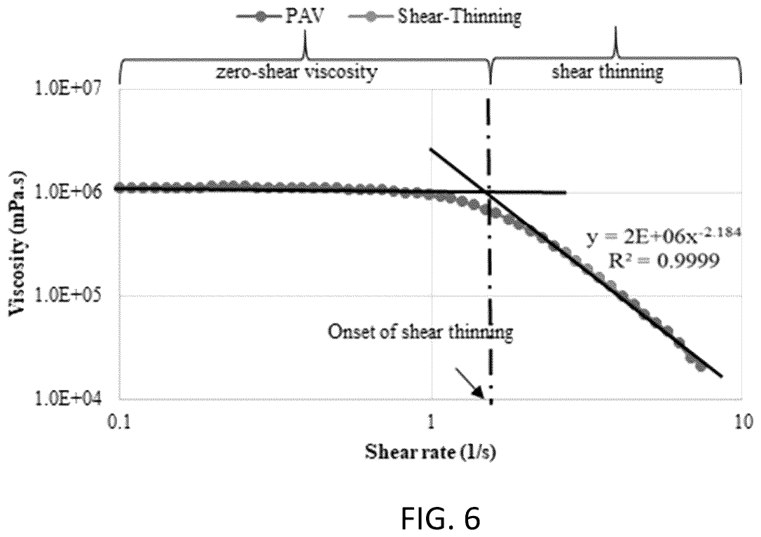

Moisture-induced shear-thinning index (MISTI). The moisture-induced shear-thinning index (MISTI) was developed to quantify the susceptibility of a bitumen-aggregate interface to moisture damage. MISTI was used to examine the efficacy of OS1, a newly engineered tack coat, at four stages of application: before curing, after curing, after short-term aging, and after long-term aging. To do so, a shear-rate ramp test was performed on a mixture of stones and bitumen containing OS1, using a dynamic shear rheometer (Anton Paar MCR 302 DSR) with an 8-mm spindle. A mixture containing a 2:1 to 3:1 ratio of OS1-based bitumen and glass beads was placed in silicon molds to form 8-mm disk-shaped specimens. Each specimen was then demolded and placed in a parallel-plate test setup of a DSR to be tested as shown in FIG. 5. A ramping shear rate (0.1 to 100 1/s) was applied to the specimen, and the viscosity value was measured at each shear rate. The testing temperature was adjusted so that the initial viscosity was close to 1000 Pa s. A plot of viscosity versus shear rate as provided in FIG. 6 was then used for analysis. Application dosages of OS1 were 0.1%, 0.5%, 0.6%, 0.7%, 0.8%, 0.9%, and 1% by weight of bitumen. For each OS1-modified bitumen sample, two samples were tested while remaining unconditioned, and the other two samples were conditioned in distilled water at 60° C. for about 24 hours before testing. After that, for each bitumen sample, the MISTI value was determined using Eq. 2, based on the shear-thinning slopes before and after water conditioning. The change in shear-thinning slope after water conditioning is closely related to the effect of water at the interface between the bitumen and the glass beads. A MISTI value closer to 1 indicates better resistance to moisture damage.

$$MISTI = \frac{Average shear - thinning slope of unconditioned samples}{Average shear - thinning slope of water - conditioned samples} \qquad ( 2 )$$

Contact-angle measurements and hydrolysis. Water contact-angle measurements were performed on a Rame-Hart 260 contact-angle goniometer; the measurements were used to examine the hydrophobicity of silane coatings and the effects of different casting, curing, and hydrolysis conditions. A 2 mL droplet of DI water was placed on the sample, and the contact angle was measured. DROPimage Advanced software was used for image capture and analysis. An average of eight measurements per sample was taken.

For hydrolysis tests, samples were immersed in 70 mL DI water in a closed reaction vessel and heated with stirring in a Discovery 2.0 microwave reactor (CEM Corp.) for 15 min at 110° C. They were briefly rinsed with DI water and blown dry under a gentle stream of compressed air before measuring the water contact angle.

Pull-off force measurements. A custom-built apparatus described in a previous publication was used for measurements of pull-off forces of either OS1-coated glass or UV-ozone-cleaned glass from a bitumen surface. Hemispherical glass cabochons (1 cm in diameter, available from arts-and-crafts suppliers) were coated with OS1 by immersion in a 1:20 v/v solution for at least one hour, followed by briefly rinsing them with water and curing them on a hotplate at 120° C. for 15 min. The glass cabochons were then hung by light thread from an FGV-2XY digital force meter (0.01-10 N force range, Nidec-Shimpo Corp.). The bitumen sample was placed on a sample stage that was manually elevated to gently lift the sample up into contact with the glass cabochon. The glass cabochon was allowed to rest on the sample surface under its own weight (˜0.7 g) for 10 min under ambient laboratory conditions (20° C.). The sample was then pushed down quickly (>5 cm/s) to pull the glass bead from the surface, and the maximum pull-off force was recorded. The measurements of pull-off force were repeated three times for each surface treatment.

Computational modeling method. Density functional theory (DFT) was used to characterize the intermolecular interactions between OS1 molecules and between OS1 and a silica cluster model, in the absence of water and in the presence of water. Calculations were done using the Dmol3 modulus implemented in the Accelrys Materials Studio program package (version 7). The Perdew-Burke-Ernzerhof (PBE) exchange-correlation functional with Grimme's dispersion correction (PBE-D) and the all-electron double-numerical polarized basis set (DNP) were used. The convergence criteria for the geometry optimizations were 2.0×10⁻⁵ hartree, 4.0×10⁻³ hartree/A, and 5.0×10⁻³ Å for energy, maximum force, and displacement, respectively. Interaction energies were calculated using Eq. 3:

$${E}_{int} = {E}_{complex} - ( \sum {E}_{fragment} ) \qquad ( 3 )$$

where E_{complex}=the total energy of the interacting complex and E_{fragment}=the energy of a fragment within the complex.

Modeling the silica cluster. Using a preliminary Periodic Boundary Condition (PBC) approach, a 3×3×1 Å super cell was built from the unit cell of α-quartz with optimized parameters a=b=4.928 Å, c=5.428 Å, α=β=90.0°, and γ=120.0°. The silica super cell was fully optimized at the PBE-D level and with quality of “fine” grid using the CASTEP modulus embedded in the Accelrys Materials Studio program package (version 7), and a (001) Miller basal plane was cleaved out of the optimized super cell. Dangling bonds were saturated with H and OH end groups, and the periodic condition was removed to obtain the silica cluster model.

Modeling the OS1 and water. Butyl(triethoxy)silane was used as a molecular model for OS1 organosilane. According to the coating mechanism of an organosilane, the polar hydrolysable ethoxy heads are hydrolyzed to hydroxyl (OH) groups, which can further coordinate with the other hydrolyzed OS1 molecules or with silanol groups on a silica surface. A dimer of butyl(triethoxy)silane was used to model a condensed organosilane. For the interaction of water with systems, three water clusters were used, each composed of six water molecules.

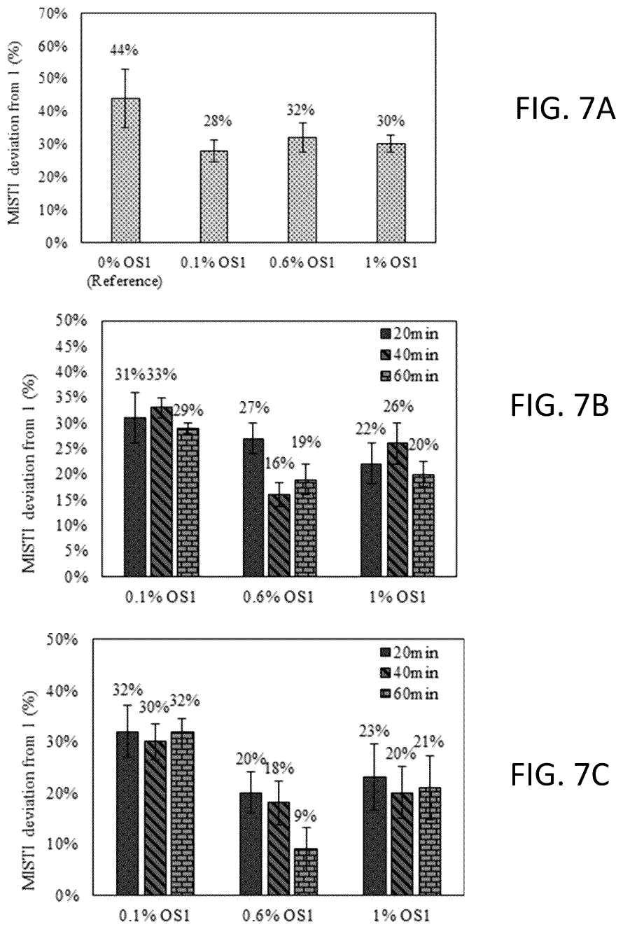

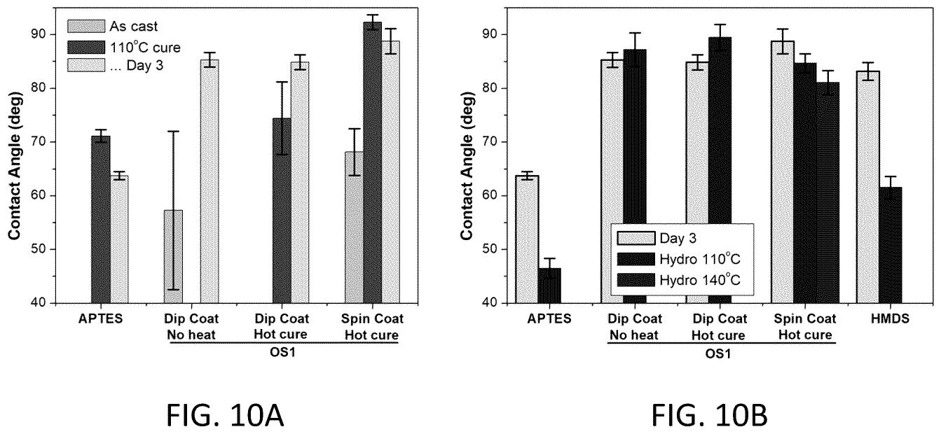

Effects of organosilane concentration on resistance to moisture at the bitumen-silica interface. FIG. 7A shows the deviation of MISTI from 1 for reference bitumen and bitumens containing 0.1%, 0.6%, and 1% OS1 before curing. A deviation of MISTI from 1 of 10% or less indicates good resistance against moisture damage. All MISTI values in FIG. 10A are higher than 10%, so all bitumens exhibited high susceptibility to moisture damage. Hence, no improvements in moisture susceptibility were observed with the addition of OS1 to bitumen without curing.

Effect of curing time and temperature on resistance to moisture at the bitumen-silica interface. The effects of curing time and curing temperature were studied for curing times of 0, 20, 40, and 60 minutes and curing temperatures of 130° C. to about 150° C., to determine the optimal time and temperature to activate the working mechanism of OS1 on siliceous substrates.

FIG. 7B shows MISTI deviations from 1 after curing at a temperature of 130° C. for three different durations (20, 40, or 60 minutes), for bitumens containing OS1. FIG. 7B shows that all bitumens had high susceptibility to moisture damage, as evidenced by MISTI deviations >10%. This means that the curing temperature of 130° C. was not sufficient to enhance bonding of OS1 with silica, or it would require a longer curing time to ensure that this bonding would occur. Hence, the curing temperature was raised to 150° C. FIG. 7C shows MISTI deviations from 1 after curing at a temperature of 150° C. for three different durations (20, 40, or 60 minutes), for bitumens containing OS1. Only the 0.6% OS1 bitumen cured for 60 min exhibited good resistance to moisture damage (MISTI deviation ≤10%), with a MISTI deviation of 9%. This improvement in moisture resistance was an indication of the positive effect of curing on OS1 films. OS1 films are dynamic until cured (with heat or time). Once cured, OS1 monolayers bonded to silica appear hydrolytically stable.

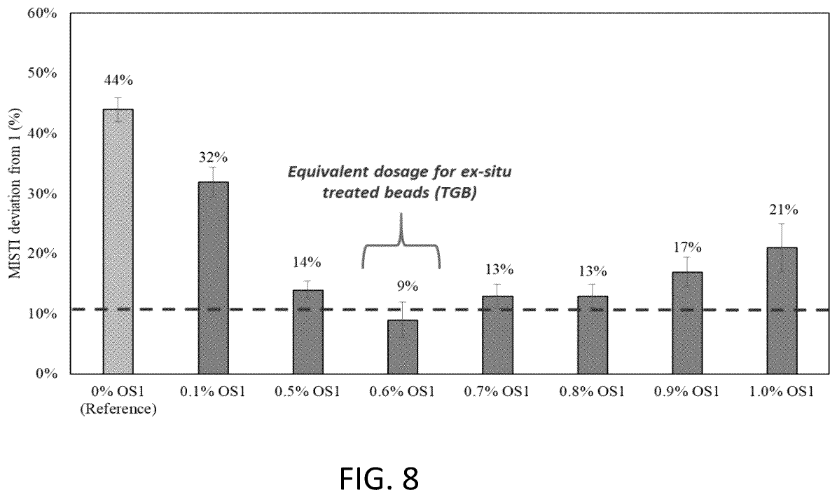

Since the best scenario was found for 0.6% OS1 cured at about 150° C. for about 60 min (which showed good resistance to moisture damage), several dosages of OS1-modified bitumen were prepared and exposed to the same curing time and temperature. FIG. 8 shows the deviation of MISTI from 1 for these bitumen samples. The best resistance to moisture damage (lowest MISTI deviation from 1) was found again for 0.6% OS1-based bitumen. At an optimum dosage 0.6% OS1, the property changes due to water exposure in OS1-modified bitumen were minimal. FIG. 8 shows that when an amount of OS1 greater than 0.6% was used, the bitumen's susceptibility to moisture damage increased. This phenomenon may be due to the aggregation of organosilane and subsequent hydrolysis. This could lead to reduced wet strength, as measured by an increase in the deviation of the MISTI when the bitumen is exposed to water. MISTI measurements suggest that for OS1 added directly to bitumen, 0.6% OS1 offers advantageous resistance, with MISTI-measured performance statistically comparable within a range of 0.5-0.8% OS1. For comparison, direct coating of the glass beads with OS1 (TGB) yields a MISTI deviation of 11% (dashed line in FIG. 8). Direct coating of glass/aggregate with OS1 offered MISTI-measured performance that is statistically comparable to 0.6% OS1.

Effect of aging on resistance to moisture at the bitumen-silica interface. The effect of aging on the efficacy of OS1 was examined by exposing OS1-modified bitumen to laboratory aging via a rolling thin-film oven (RTFO) and a pressure aging vessel (PAV). Aging can cause changes in the compositional and surface properties of bitumen. Adhesion promoters may be susceptible to thermal and oxidative degradation, thereby losing their efficacy with aging. The following tests report on the performance of OS1 after short-term aging and after long-term-aging.

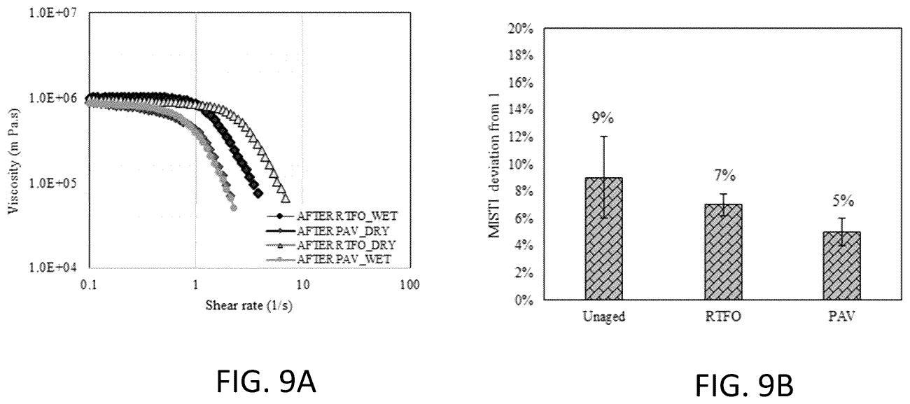

FIG. 9A shows the viscosity at different shear rates for the optimum OS1-bitumen (0.6% OS1) after short-term aging and long-term aging. FIG. 9B shows the deviation of MISTI from 1 for this bitumen at unaged, after RTFO aging, and after PAV aging. Improvements in moisture resistance were observed with progressive aging, as evidenced by reductions with aging in the MISTI deviation from 1. The MISTI deviation from 1 after RTFO aging was 7% and after PAV aging was 5%. Hence, the 0.6% OS1 bitumen's susceptibility to moisture damage decreased by 22% after short-term aging and from that point decreased an additional 29% after long-term aging. (The total decrease in susceptibility to moisture damage from the initial MISTI deviation of 9% to the final MISTI deviation of 5% was 44%.) The performance of the optimum OS1-modified bitumen (0.6% OS1 cured at 150° C. for 60 min) was not reduced after being exposed to short-term aging and long-term aging, as evidenced by MISTI measurements. This indicates that the OS1 bonding to silica is stable, even after aging; hence, the OS1-modified sample has low susceptibility to thermal degradation and oxidative degradation.

Contact-angle measurements. FIGS. 10A and 10B show the results of contact-angle measurements on different silane coatings. Whether spin-cast or dip-cast, OS1 coatings were not fully hydrophobic until cured with either heat or time. Dip-coating led to excess OS1 solution drying down on the sample, resulting in thick, uneven coatings that were not fully cured after 15 min at 110° C. Spin-coating gave uniform films suitable for laboratory measurements. All samples appeared to be sufficiently cured after 3 days at room temperature, showing contact angles of about 90°. After hydrolysis at 110° C., OS1 coatings showed no significant change as shown in FIG. 10B. Even after hydrolysis at a higher temperature (140° C.), the spin-coated OS1 film showed only a marginal decrease in contact angle. In comparison, silane layers of aminopropyl-triethyoxysilane (APTES) or hexamethyldisilazane (HMDS) showed significant decreases in contact angle after hydrolysis. Visual inspection of the thick, dip-cast OS1 films showed that much of the excess OS1 was removed by the hydrolytic treatment. The excess amount of OS1 in the thick OS1 film has weaker binding to the first thin OS1 layer on a glass slide; this observation is further explained using molecular modeling calculations in the DFT section.

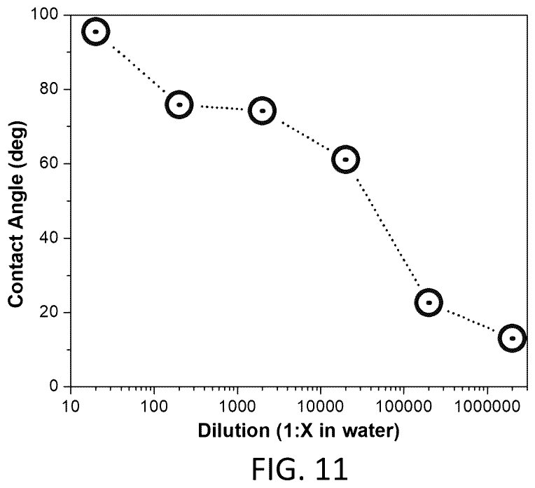

FIG. 11 shows a plot of contact-angle measurements of OS1 spin-coated from diluted aqueous solutions. Contact angles of ≥60° were obtained from OS1 solutions diluted as much as 1:20000 in water. Substantial error in these measurements may arise from the poor solubility and surfactant-like behavior of OS1 in water at high dilutions, but these measurements may be useful for investigating and qualifying the performance of incomplete OS1 coatings.

Pull-off force measurements. Pull-off force measurements of glass beads with or without OS1 coating from contact with a neat bitumen surface were made. The measurements gave a pull-off force of 0.19±0.08 N for OS1-coated glass, compared to a pull-off force of 0.37±0.22 N for glass cabochons cleaned in a UV-ozone cleaner, indicating a reduction in dry adhesion by the OS1. Visual inspection of the surface of the glass cabochon after pull-off also gives a qualitative indication of how much of the detachment resulted from cohesive failure of the bitumen (e.g., bitumen sticks to the glass cabochon) or adhesive failure of the interface (e.g., glass separates cleanly). The glass coated with OS1 separated cleanly from the bitumen (indicative of complete adhesive failure) on two out of three pulls, whereas separation of the UV-cleaned glass from bitumen was never clean.

Density functional theory calculations. The active material in the OS1 disclosed here is a silane coupling agent (an alkoxy-alkylsilyl compound) that can permanently bind to the hydrophilic surfaces of aggregates in an asphalt mixture and make the aggregates water-repellent. In addition, the hydrophobic tails of OS1 can interact well with the hydrocarbons in bitumen, enhancing the bitumen-aggregate adhesion. Interactions of the silanol groups of the OS1 with the silanol groups on the surface of an aggregate such as silica result in the formation of covalent bonds between the two species, providing a water-resistant film on silica. OS1 molecules can also interact with each other to form a multimolecular structure of bound silane coupling agents on silica. The adsorbed first layer of OS1 on silica in which the OS1 is directly attached to the silica via covalent bonds is stable in the presence of water; however, the mechanism may differ for those OS1 compounds that form a second or a third layer on silica through non-covalent interactions. DFT calculations were used to analyze different intermolecular interactions. The OS1 organosilane modifier was modeled as a butyl(triethoxy)silane dimer in the DFT calculations.

In the first step, the OS1-silica and OS1-OS1 interactions were calculated in which hydrogen bonds were formed between the interacting molecules. The results showed that the OS1-silica complex was stabilized by three hydrogen bonds between the OH^{δ+} groups of the OS1 and the ^{-δ}OH groups on the silica surface, with −34.6 kcal/mol interaction energy. To evaluate the OS1-OS1 interactions, two orientations were considered: side-to-side and face-to-face. The calculated interaction energies were −19.7 kcal/mol for the side-to-side interactions and −26.5 kcal/mol for the face-to-face interaction. The face-to-face orientation led to the formation of more hydrogen bonds, leading to a higher interaction energy value for this complex compared to the side-by-side complex. However, the interaction energies of both OS1-OS1 complexes were lower than that of the OS1-silica complex.

In the next step, the effects of water on the interactions were analyzed. For these calculations, three water clusters were optimized, each containing six water molecules. The water clusters were placed around the interaction sites of the two fragments, and the systems were re-optimized to obtain the new interaction energies. The results showed that these interactions are highly susceptible to the presence of water, with disruption of hydrogen bonds in by the presence of water molecules. According to the calculations, there were decreases in interaction energies of 33% for OS1-silica, 32% for face-to-face OS1-OS1, and 34% for side-to-side OS1-OS1. Organosilane coupling agents have a high affinity to form covalent bonds with a silica surface. Hence, although the results show the water-susceptibility of the hydrogen-bonded OS1-silica complex, the probability of having this structure in the first coating layer on silica is not significant. Therefore, the disruption of the hydrogen-bond network within the deposited upper layers of organosilane on silica can lead to intercalation of water into this medium, and this can be the dominant reason for the weakening of the adhesion strength between the coated silica component and the bitumen component.

Once the silica is covered by organosilane compounds, the excess amount of organosilane can interact with the first adsorbed organosilane layer on silica and with other organosilane molecules. The OS1-OS1 interactions whose strengths were previously calculated were in an isolated medium. In fact, the OS1 molecules in the upper adsorbed layers (which are called L2-OS1 and L3-OS1 in this work) interact with the L1-OS1-silica complex. To further analyze these types of interactions, two new systems were considered: a) a system in which an L2-OS1 was placed on top of the OS1 molecule of the first layer (L1-OS1), a configuration where polar interaction between the silanol groups of L1-OS1 and L2-OS1 is not available; and b) a system in which an L3-OS1 was adsorbed on top of the L2-OS1, a configuration where hydrogen-bond formation between the two species is available. The calculations showed that the adsorption of L2-OS1 on top of the first adsorbed OS1 is consistent with −11.1 kcal/mol interaction energy, which is less than the interaction energies of both the OS1-silica complex and the isolated OS1-OS1 complexes, respectively. As mentioned, the silanol groups of the L1-OS1 were not accessible to the L2-OS1 in this geometry.

Although the orientation of the L2-OS1 in the latter complex provides available silanol groups to form hydrogen bonds with the third OS1 molecule (L3-OS1), the results showed that even in this case, the interaction energy (−14.5 kcal/mol) is still lower than those obtained for the OS1-silica and isolated OS1-OS1 interactions. Weaker interactions of the organosilane molecules within the adsorbed upper layers facilitate the intercalation of water into the complex, disrupting the required adhesion between the bitumen hydrocarbons and siliceous aggregates. This shows that the efficiency of organosilane is dependent on its saturation level on aggregates: when only a single layer of covalently-bonded OS1 is formed on the aggregates, the bitumen-aggregate adhesion is improved; higher doses of OS1 lead to the formation of upper layers of organosilane, which have a negative impact on the bitumen-aggregate adhesion.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A composition comprising:
bitumen;
a multiplicity of particles comprising silicate; and
a modifier comprising one or more organosilanes, one or more bio-oils, or a combination of one or more organosilanes and one or more bio-oils, wherein the modifier at least partially coats each particle of the multiplicity of particles.

2. The composition of claim 1, wherein the one or more bio-oils comprise waste bio-oils.

3. The composition of claim 1, wherein the one or more bio-oils comprise aromatic and aliphatic groups.

4. The composition of claim 1, wherein the one or more bio-oils comprise nitrogen heteroatoms, oxygen heteroatoms, or both.

5. The composition of claim 1, wherein the bio-oils comprise one or more of N-methyl-2-pyrrolidone, 1-butyl-piperidine, p-presol, and 1-methyl-9H-pyrido[3,4-b] indole.

6. The composition of claim 1, wherein the one or more organosilanes comprise one or more silicon atoms, a polar hydrolysable head group, and a hydrophobic organic tail group.

7. The composition of claim 1, wherein the one or more organosilanes comprise one or more of butyl(triethoxy)silane, triethoxyoctylsilane, triethoxy(tert-pentyl)silane, triethoxy(heptyl)silane, and triethyl(pentyloxy)silane.

8. The composition of claim 1, wherein the multiplicity of particles comprising silicate comprises aggregates.

9. The composition of claim 8, wherein the aggregate comprises one or more of sand, gravel, crushed stone, slag, or rock dust.

10. The composition of claim 1, wherein the modifier at least partially coating each particle of the multiplicity of particles comprises the modifier chemisorbed, physisorbed, or both to a surface of each particle of the multiplicity of particles.

11. A method of making a modified bitumen composite, the method comprising:
combining bitumen, a multiplicity of particles comprising silicate, and a modifier to form a mixture, wherein the modifier comprises one or more organosilanes, one or more bio-oils, or a combination of one or more organosilanes and one or more bio-oils; and
heating the mixture to yield the modified bitumen composite.

12. The method of claim 11, wherein a weight ratio of the one or more bio-oils to bitumen is in a range of about 1:50 to about 1:4.

13. The method of claim 11, wherein a weight ratio of the one or more organosilanes to bitumen is in a range of 0.55:100 to about 0.65:100.

14. The method of claim 11, wherein a weight ratio of the one or more organosilanes to bitumen is in a range of about 0.1:100 to about 1:100.

15. The method of claim 11, wherein heating the mixture comprises heating the mixture to a temperature in a range of about 100° C. to about 180° C. for a length of time in a range of about 5 minutes to about 120 minutes.

16. The method of claim 11, wherein the one or more bio-oils comprise nitrogen heteroatoms, oxygen heteroatoms, or both.

17. The method of claim 11, wherein the one or more bio-oils comprise one or more of N-methyl-2-pyrrolidone, 1-butyl-piperidine, p-presol, and 1-methyl-9H-pyrido[3,4-b] indole.

18. The method of claim 11, wherein the one or more organosilanes comprise one or more silicon atoms, a polar hydrolysable head group, and a hydrophobic organic tail group.

19. The method of claim 11, wherein the one or more organosilane comprises one or more of butyl(triethoxy)silane, triethoxyoctylsilane, triethoxy(tert-pentyl)silane, triethoxy(heptyl)silane, and triethyl(pentyloxy)silane.

20. The method of claim 11, wherein the multiplicity of particles comprising silicate comprises aggregate.
